(19) United States
(12) Patent Application Publication
(10) Pub. No.: US 2014/0220552 A1
(43) Pub. Date: Aug. 7, 2014

(54) BLOOD COLLECTION DEVICES CONTAINING CONTACT PATHWAY INHIBITION ADDITIVES

(71) Applicant: Becton, Dickinson and Company, Franklin Lakes, NJ (US)

(72) Inventors: Keith A. Moskowitz, Monroe, NY (US); Frank L. Sinquett, Springfield, NJ (US)

(73) Assignee: BECTON, DICKINSON AND COMPANY, Franklin Lakes, NJ (US)

(21) Appl. No.: 14/169,290

(22) Filed: Jan. 31, 2014

Related U.S. Application Data
(60) Provisional application No. 61/759,742, filed on Feb. 1, 2013.

(51) Int. Cl. A01N 1/02

(52) U.S. Cl. CPC A01N 1/0226
USPC 435/2; 435/307.1

(57) ABSTRACT

Disclosed are devices for collecting blood that contain an anti-coagulant and an additive that delays clotting by inhibiting the contact pathway for thrombin generation. The additive is a coagulation contact pathway inhibitor additive that is at least one of a Factor XI inhibitor, a Factor XII inhibitor, a kallikrein inhibitor and combinations thereof, each in an amount effective to mediate or suppress the contact pathway for thrombin generation. Methods of making and using the devices, and kits containing the devices, are also provided.

### CROSS REFERENCE TO RELATED APPLICATIONS

This application claims the benefit of the filing date of U.S. Provisional Patent Application No. 61/759,742 filed Feb. 1, 2013, the disclosure of which is hereby incorporated herein by reference.

### BACKGROUND OF THE INVENTION

It is well known that blood and plasma will clot when exposed to conditions that activate the coagulation pathway that ultimately forms fibrin. Fibrin itself is formed through the activity of thrombin and is therefore a consequence of thrombin generation. Thrombin generation is initiated by two enzymatic cascades involving several different factors (peptidases) that eventually converge in a common pathway which produces active thrombin. The two cascades that result in thrombin formation are the tissue factor (TF) coagulation pathway (also known as the extrinsic pathway) and the contact coagulation pathways (also known as the intrinsic pathway). The TF pathway is initiated through the exposure of circulating factor VII to endothelial and subendothelial expressed TF which occurs with vascular damage (i.e., venipuncture). Subsequent conversion of factor VII to factor VIIa results in a TF-VIIa complex that promotes the conversion of factor X to factor Xa (the active form of factor X) both directly and through the conversion of factor IX to factor IXa (activated IXa) which then converts X to Xa. The production of factor Xa facilitates the conversion of prothrombin into thrombin. Thrombin can then convert fibrinogen to fibrin.

Thrombin is also generated via the contact or intrinsic coagulation pathway, which occurs when blood comes in contact with a foreign surface, particularly negatively charged surfaces. Examples of ex vivo contact pathway activators include glass, silica, kaolin and to a lesser extent plastic. The contact pathway is initiated by an ensemble of enzymes that includes factor XII, factor XI, high-molecular-weight kininogen (HMK), and prekallikrein, which organize on the activating surface resulting in the formation of factor XIIa (the active form of factor XII). Kallikrein, the active form of prekallikrein, can proteolytically generate factor XIIa which in turn can proteolytically convert prekallikrein to kallikrein. The net effect of these interactions is the initiation of the contact coagulation pathway via the amplification and accumulation of factor XIIa in blood and the subsequent conversion of factor XI to factor XIa. Factor XIa then catalyzes the conversion of factor IX to factor IXa. From there, the contact and TF pathways follow the same course described above (common pathway).

During blood collection, blood is exposed to foreign surfaces such as the cannula, tubing, and the wall of the blood containment device (i.e., evacuated blood collection tube). This contact activates the intrinsic (contact) coagulation pathway which, as described above, results in the conversion of factor XII into active factor XII (FXIIa). If left unchecked, FXIIa will convert FXI into FXIa which will then convert FIX into FIXa. This cascade eventually results in active thrombin generation and fibrin clot formation.

When blood samples are collected, it is desirable to suppress clot formation. Chelating agents such as sodium citrate are added to blood collection tubes to help reduce thrombin generation and fibrin clot formation. As blood mixes with sodium citrate, the calcium dependent activities of factor XIa, factor IXa, and factor Xa are arrested preventing thrombin generation and hence suppressing clot formation.

Other methods are known in the art to prevent thrombin generation through the contact coagulation pathway. Among these methods is the inhibition of factor XIIa activity which directly inhibits factor XIIa mediated conversion of factor XI into factor XIa. Corn trypsin inhibitor (CTI) is one inhibitor known in the art to inhibit factor XIIa mediated conversion of factor XI to factor XIa. However, several problems exist with using CTI to suppress thrombin generation via the contact coagulation pathway. One such problem is the amplification of accumulated factor XIIa via involvement of the kallikrein-kinin system. Another problem is that blood collection tubes that include CTI cannot be sterilized and thus cannot be used in conjunction with certain clinical applications.

Two applications used to monitor thrombin generation and clotting are Thrombelastography (TEG) and Calibrated Automated Thrombogram (CAT) assay. TEG is an important assay used in surgery and anesthesiology that assesses platelet function, clot strength, and fibrinolysis that other tests, such as aPPT, cannot. TEG measures coagulation by taking a patient's blood and rotating gently (e.g., 6 times per minute) at an angle of 4° to 45°. A thin wire placed in the collection apparatus used for TEG measures the formation of the clot through thrombin generation. Generation of thrombin through the contact pathway can skew TEG results depending on the vessel or container used in the test.

The CAT assay is a tool used to investigate patients with hypo- or hypercoagulable phenotypes. In this assay, thrombin generation is induced by TF, phospholipids and CaCl₂. Because this assay depends on the generation of thrombin by TF, contact pathway based generation of thrombin will distort the CAT assay results.

Thus, a need remains for a composition and method that selectively inhibits the contact coagulation pathway for thrombin generation in collected blood samples for both TEG and the CAT assay. Preferably such compositions and methods are independent of the laboratory vessel or container used for blood collection testing.

### BRIEF SUMMARY OF THE INVENTION

One aspect of the present invention is directed to a device for collecting blood (e.g., a whole blood sample) or a composition containing a component of blood (e.g., plasma) that has a first end and a second end and at least one interior wall defining a reservoir portion for receiving the blood or component thereof. The reservoir contains an additive, or combination of additives, that inhibits contact coagulation pathway activation, each in an amount effective to stabilize thrombin generation in blood or blood components mediated by contact coagulation pathway activation. These additives are referred to as contact pathway inhibitors as they inhibit the contact coagulation cascade pathway that leads to thrombin generation. Although applicants do not wish to be held to a particular theory, applicants believe that the additives contemplated herein block at least one of factor XIa (FXIa) activity, Factor XIIa activity, or kallikrein activity, or any combination thereof. Blocking FXIa activity has a very robust effect without the need for simultaneous FXII inhibition. In one embodiment, the use of contact pathway inhibitors in combination with sodium citrate evacuated blood collection tubes significantly extends the clotting time for collected blood in such tubes. In some embodiments, the collection device is fitted with a closure pierceable by a needle (e.g., for supplying blood to the reservoir) and is sterile and evacuated.

Another aspect of the present invention is directed to a method for collecting blood or a composition containing a component thereof (e.g., plasma) in which the contact pathway to coagulation is inhibited, comprising introducing the blood or the composition into a device that has a first end and a second end and at least one interior wall defining a reservoir portion for receiving the blood or composition, and a contact pathway inhibition additive (additive herein) disposed in the reservoir in addition to citrate. In certain embodiments the additive is a kallikrein inhibitor. In other embodiments the additive includes at least one of: i) a factor XI inhibitor that is, for example and not limited to anti-human FXI antibodies; ii) a factor XII inhibitor; and iii) a kallikrein inhibitor; and iv) any combination of i, ii and iii. Examples of factor XII inhibitors include but are not limited to corn trypsin inhibitor. Examples of kallikrein inhibitors include but are not limited to aprotinin. Aprotinin is provided in an amount effective to suppress thrombin formation through the contact coagulation pathway. Such amounts exceed the amounts of aprotinin present when used as a broad base serine protease inhibitor in tubes where the blood is collected and preserved. Such tubes typically contain [EDTA] and other stabilizers not present in the tubes described herein. Subsequent to collection and storage, the blood or the composition may be utilized, e.g., for diagnostic analysis or therapeutic purposes. The concentration of kallikrein inhibitor, (e.g., aprotinin) is about 500 kallikrein inhibitor units (KIU) to about 5000 KIU/mL in sample (e.g., blood). The concentration of the anti-human Factor XI antibodies, if present, is about 2 μg/mL to about 14 μg/mL in sample (e.g., blood).

A further aspect of the present invention is directed to a package or kit that includes at least one such device (and preferably a plurality of such devices).

### BRIEF DESCRIPTION OF THE DRAWINGS

FIG. 1 is a schematic of a conventional evacuated collection tube in which the additive of the present invention is placed.

FIG. 2A is a table comparing citrated-native clotting times for tubes made from various materials.

FIG. 2B is a chart of the data contained in 2A.

FIG. 3A is a table comparing thrombin generation assay performance in both the presence and absence of TF for citrated plasma samples derived from tubes of various materials.

FIG. 3B is a chart of thrombin generation curves from which values in FIG. 3A were derived.

FIG. 4A is a set of graphs showing the dose-dependent inhibition of the contact coagulation pathway upstream of Factor XIIa using aprotinin.

FIG. 4B is a graph showing thrombin generation curves without tissue factor (TF) using a Calibrated Automated Thrombogram (CAT) assay, illustrating the severity of contact pathway contribution from both glass and plastic products, as well as the mitigation provided by the additive descried herein.

FIG. 5A is a graph showing the dose-dependent ability of monoclonal anti-FXI antibody to prolong citrated-native whole blood clotting times from samples incubated in glass citrate tubes.

FIG. 5B is a chart showing the mitigation of the contact pathway activation downstream of Factor XIIa by anti-Factor XI antibodies in the absence of TF.

FIG. 6 are graphs showing the selective inhibition of the contact coagulation pathway with aprotinin and anti-Factor XI antibodies while preserving TF driven thrombin generation and thrombin activity.

FIG. 7 are charts showing selective inhibition of kallikrein with aprotinin and factor XI inhibition using anti-Factor XI antibodies provides contact pathway mitigation equivalent to contact pathway mitigation using CTI to inhibit factor XIIa.

### DETAILED DESCRIPTION

Broadly, the collection devices of the present invention can encompass any collection device including tubes such as test tubes and centrifuge tubes; closed system blood collection devices, such as collection bags; syringes, especially pre-filled syringes; catheters; microtiter and other multi-well plates; arrays; tubing; laboratory vessels such as flasks, spinner flasks, roller bottles, vials, microscope slides, microscope slide assemblies, coverslips, films and porous substrates and assemblies; pipettes and pipette tips; tissue and other biological sample collection containers; and any other container suitable for holding a biological sample, as well as containers and elements involved in transferring samples. Examples and illustrations of several such devices are disclosed in commonly owned U.S. Pat. No. 7,309,468 to Stevens et al. The device may be evacuated and sterile, and include a closure pierceable by a needle. Alternatively, the device may be a partially-evacuated or a non-evacuated system for collecting blood. A suitable example of an evacuated system is a closed tube. A manual syringe draw is a suitable example of both a partially-evacuated and a non-evacuated system. Non-evacuated systems may also include automatic draw systems.

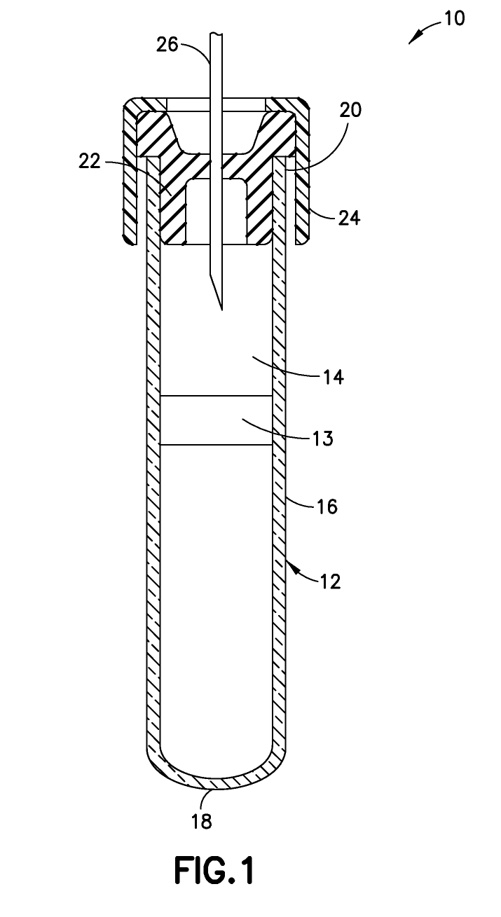

FIG. 1, which is also illustrated in U.S. Pat. No. 7,309,468, shows a typical blood collection device 10, useful in the present invention, which includes a container 12 defining an internal chamber or reservoir 14. In the embodiment illustrated, container 12 is a hollow tube having a side wall 16, a closed bottom end 18 and an open top end 20. Optionally, a separating member 13 is provided within the container chamber 14. Separating member 13 serves to assist in separating components of the blood sample, for example, by centrifugation. Container 12 is dimensioned for collecting a suitable volume of blood. A closure means 22 for covering open end 20 to close container 12 is necessary where a sterile product is demanded. In some embodiments, the tube is configured for a screw cap. Preferably, closure 22 forms a seal capable of effectively closing container 12 and retaining a biological sample in chamber 14. Closure 22 may be one of a variety of forms including, but not limited to, rubber closures, HEMOGUARD™ closures, metallic seals, metal-banded rubber seals and seals of different polymers and designs. A protective shield 24 may overlie closure 22.

Container 12 can be made of any material suitable for laboratory vessels, including, for example plastics (e.g., polyolefins, polyamides, polyesters, silicones, polyurethanes, epoxies, acrylics, polyacrylates, polyesters, polysulfones, polymethacrylates, PEEK, polyimide and fluoropolymers) and glass products including silica glass. Preferably, container 12 is transparent. Examples of suitable transparent thermoplastic materials for container 12 include polycarbonates, polyethylene, polypropylene and polyethyleneterephthalate. Plastic materials can be oxygen-impermeable materials or may contain an oxygen-impermeable or semi-permeable layer. Alternatively, container 12 can be made of a water and air permeable plastic material.

The pressure in chamber 14 is selected to draw a predetermined volume of biological sample into chamber 14. Preferably, closure 22 is made of a resilient material that is capable of maintaining the internal pressure differential between atmospheric pressure and a pressure less than atmospheric. Closure 22 is such that it can be pierced by a needle 26 or other cannula to introduce a biological sample into container 12 as known in the art. Preferably, closure 22 is resealable. Suitable materials for closure 22 include, for example, silicone rubber, natural rubber, styrene butadiene rubber, ethylene-propylene copolymers and polychloroprene.

Suitable examples of container 12 include single-wall and multi-layer tubes. A more specific example of a suitable container 12 is disclosed in U.S. Pat. No. 5,860,937.

Container 12 may also contain a separator 13 such as a gel, a mechanical separator or other type of separating member (e.g., filter paper or the like). Separators are typically useful for blood plasma preparation, specifically to separate plasma from human or animal whole blood. In some embodiments, the separator has a density that is intermediate between white cells and platelets, and which may be useful in isolation of PRP from the other cellular elements of a whole blood sample. The gel is desirably a thixotropic polymeric gel formulation. The gel may be a homopolymer or a copolymer and may include silicone-based gels such as, for example, polysiloxanes, or organic hydrocarbon-based gels such as, for example, polyacrylics, polyesters, polyolefins, oxidized cis polybutadienes, polybutenes, blends of epoxidized soybean oil and chlorinated hydrocarbons, copolymers of diacids and propandiols, hydrogenated cyclopentadienes and copolymers of alpha-olefins with dialkylmaleates. Examples of mechanical separators that may be useful in the present invention are described in U.S. Pat. Nos. 6,516,953; 6,406,671; 6,409,528; and 6,497,325.

Container 12 may also be adapted for centrifugally separating lymphocytes and monocytes from heavier phases of a sample of whole blood. In such embodiments, the devices may also contain a liquid density gradient medium and a means for preventing mixing of the liquid density gradient medium with a blood sample prior to centrifugation. An example of a suitable lymphocyte/monocyte collection tube is disclosed in U.S. Pat. No. 5,053,134.

In other embodiments, the device may include a reservoir integrated within a testing cartridge, the reservoir capable of holding a volume of whole blood in the range of 2 through 200 microliters, more preferably 50-150 microliters. Such cartridges are sold for instance under the trade name i-STAT® Point of Care System by Abbott Laboratories (Abbott Park, Ill.), and are usable with a hand-held analyzer capable of interfacing with the cartridge. Examples of such cartridges and handheld analyzers usable with the present invention include the i-STAT® PT/INR cartridge and i-STAT® 1 handheld analyzer respectively.

In some embodiments, the device is a syringe. A syringe assembly may include a barrel having an open proximal end, a distal end and a sterile hollow chamber between the proximal and distal ends for receiving blood; a plunger located in the open proximal end; a needle secured to the barrel; and a platelet stabilizing agent within the chamber.

The devices of the present invention may be made or assembled in accordance with materials, reagents and processes known in the art. By way of example, one such method involves adding at least one contact pathway inhibiting agent (which as described herein may be in dried, lyophilized or liquid form) in an amount effective to stabilize/inhibit contact pathway mediated thrombin generation; and then optionally adding a separating member to the device, and evacuating and/or sterilizing the device.

As used herein, the terms “blood” and “blood sample” refer to whole blood, or a component thereof (e.g., a composition such as another body tissue or fluid that contains a component of blood), particularly a cellular component thereof, including for example, red blood cell concentrates, platelet concentrates (e.g., platelet-rich plasma (PRP)), leukocyte concentrates; or plasma and serum. Thus, in other embodiments, the sample may be a body fluid or tissue containing blood cells or immature blood cells, such as bone marrow.

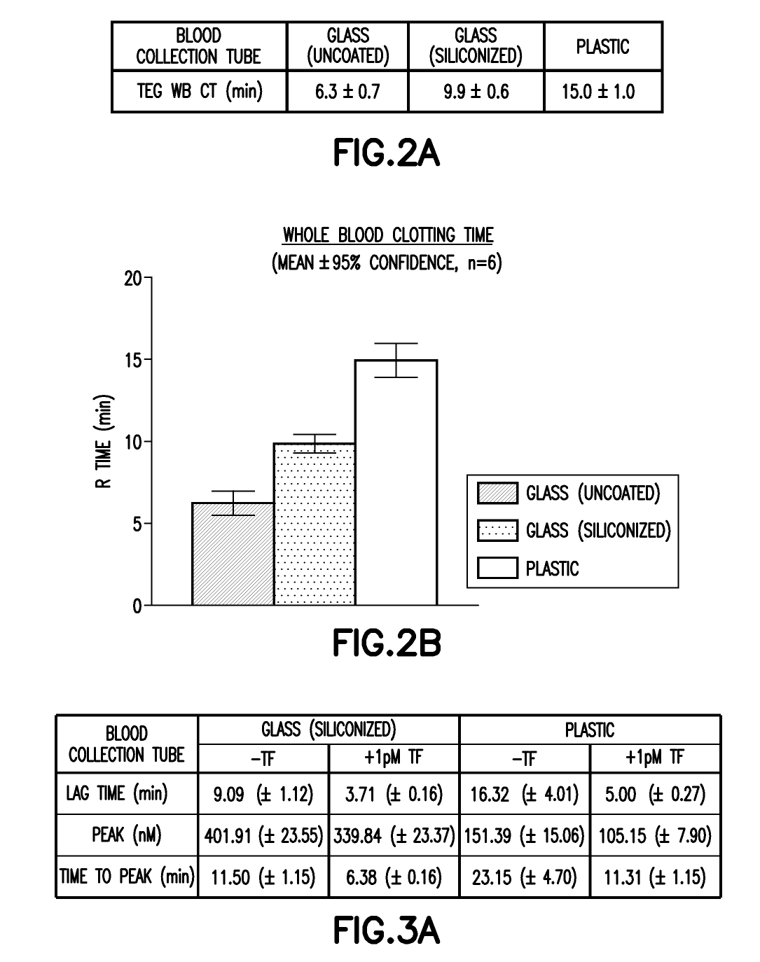

FIGS. 2A and 2B are a table and chart comparing recalcified clotting times for tubes made from various materials using a Thrombelastograph® (TEG) 5000 Hemostasis Analyzer. Citrated-native TEG using commercial citrate human whole blood demonstrates that BD Vacutainer® 369714 glass citrate tubes have significantly greater procoagulant activity compared to 363083 plastic citrate tubes. Briefly, BD Vacutainer® 369714 glass and 363083 plastic citrate tubes were washed and dried to remove the citrate additive. Afterwards, tubes were filled to capacity using a commercial bag of citrated human whole blood. Samples were incubated for 15 minutes at room temperature with gentle rocking to promote blood contact with the surface material of the tube wall. Finally, the whole blood clotting time was measured using combined recalcification and TEG. These results clearly show that plastic citrate tubes provide mitigation for pre-analytically induced accelerations in clotting time relative to glass tubes. Although applicants do not wish to be held to a particular theory, applicants believe that this difference is due to greater contact pathway activation in the siliconized glass product. Furthermore, it is important to note that only highly sensitive coagulation assays that are performed in the absence of a strong contact pathway activator will be sensitive to these differences.

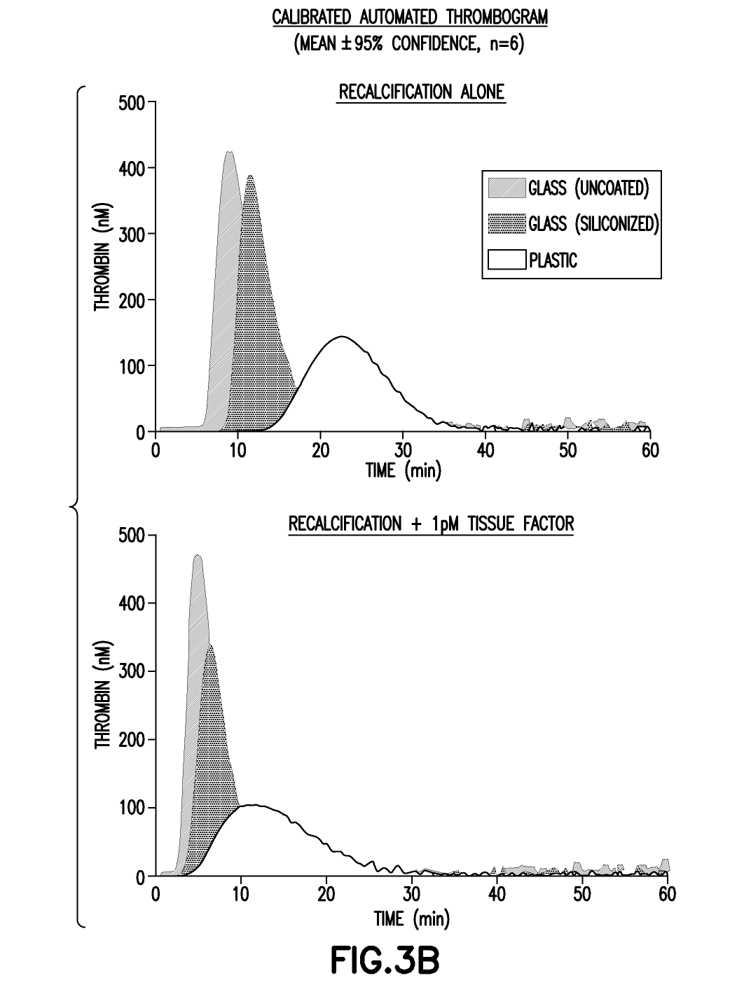

FIGS. 3A and 3B is a table and chart comparing thrombin generation from citrated plasma obtained from tubes made of various materials using the Calibrated Automated Thrombogram (CAT) assay. The CAT assay, rather than measuring coagulation, combines the use of a fluorogenic substrate that is cleaved in the presence of thrombin as well as a calibrator to provide a quantitative measurement of thrombin generation in a recalcified plasma sample. The predominant use of this assay is to examine the thrombin generation profile of a clinical research sample in response to tissue factor (TF). Tissue factor does not utilize the contact pathway to generate thrombin which makes this assay incredibly sensitive to contact activation. As shown in FIG. 3A, lag times and time to peak thrombin generation are significantly lower in citrated plasma samples from siliconized glass tubes than those from plastic tubes both in the presence and absence of 1 pM TF. These results clearly demonstrate that different surface materials used in common blood containment devices can bestow variable rates of thrombin generation. Furthermore, peak thrombin values are also higher in citrated plasma samples from siliconized glass compared to those derived from plastic tubes indicating that the intensity of thrombin generation is also vulnerable to contact coagulation pathway activation. The charts contained in FIG. 3B provide example thrombin generation curves that were used to populate the data table in FIG. 3A.

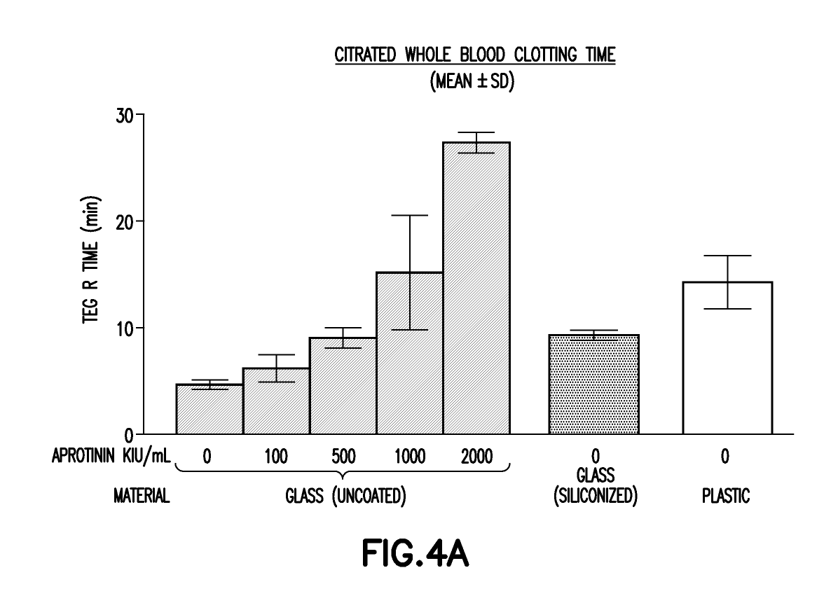

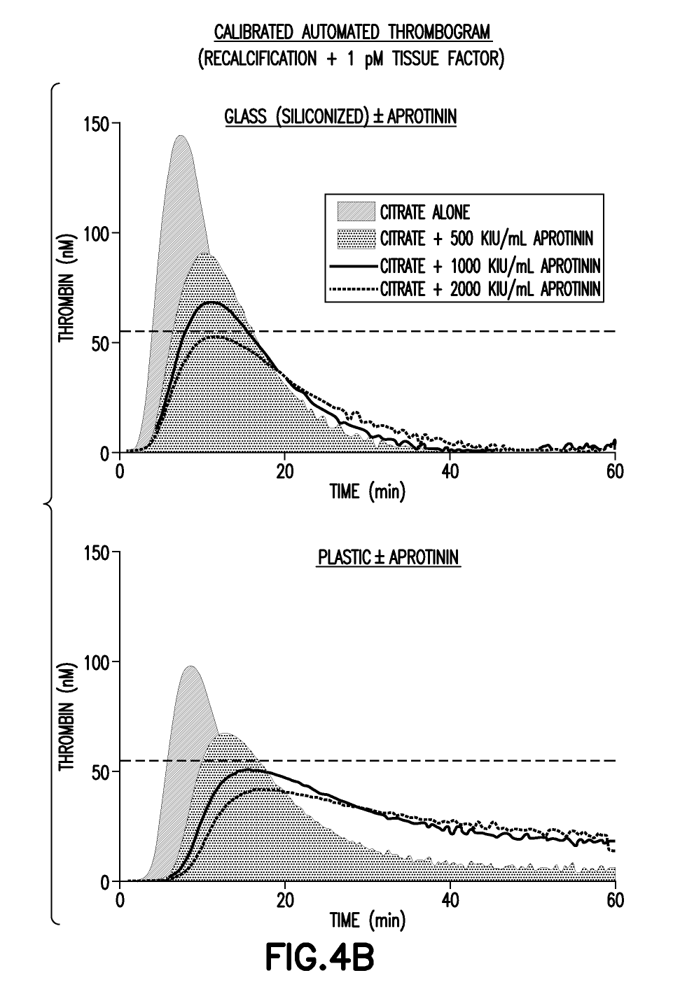

FIG. 4A demonstrates that a known kallikrein inhibitor called aprotinin can be used to block contact pathway driven coagulation when added to blood in combination with a sodium citrate background. The titration was performed by evaluating whole blood clotting time (TEG R time). A minimally effective dose was determined at 1000 kallikrein inhibitor units (1000 KIU) per mL of blood as concentrations below that only provided mean clotting times that were either equivalent or lower to that of siliconized glass. Concentrations of 2000 KIU/mL bestowed blood contained in uncoated glass with longer clotting times than that of blood stored in either siliconized glass or plastic. These results clearly implicate contact pathway activation as the underlying mechanism for pre-analytically induced decreases in clotting time as well as demonstrate a mitigation strategy beyond that of surface material.

FIG. 4B shows that aprotinin successfully delays and reduces thrombin generation in a dose dependent fashion as predicted by the whole blood titration results.

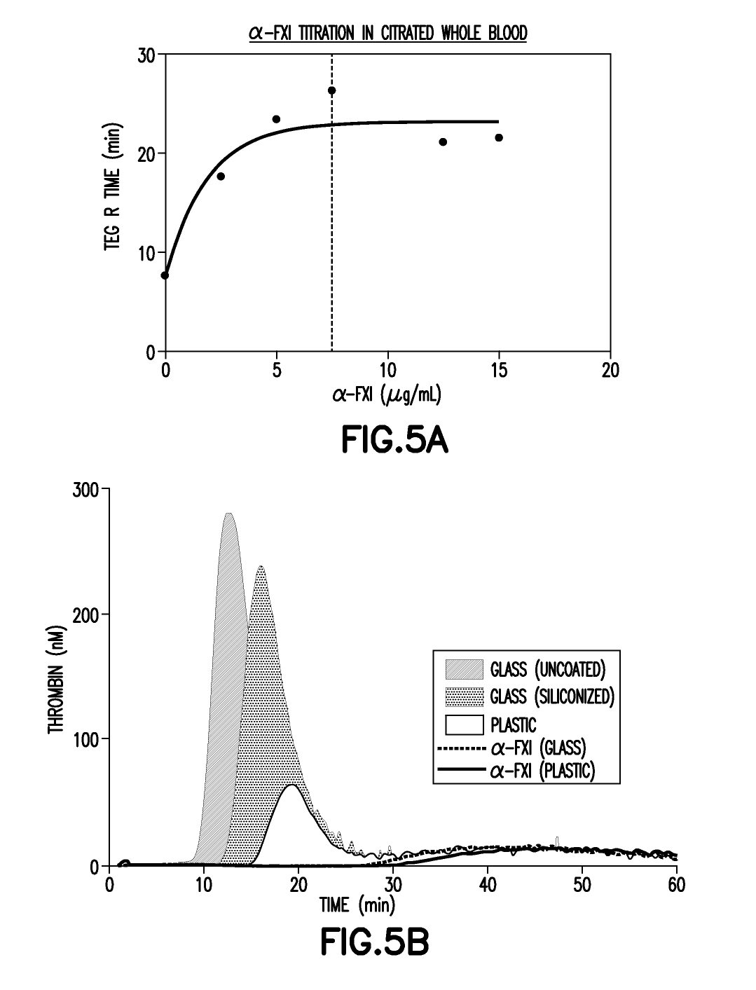

FIG. 5A shows a titration of anti-factor IX antibody (α-FXI) into whole blood incubated in siliconized glass tubes. The titration was performed by evaluating whole blood clotting time (TEG R time). The data shows that a plateau occurs somewhere above 5 μg/mL and a concentration of 7.5 μg/mL was selected for further evaluation.

FIG. 5B shows thrombin generation curves in the absence of TF. Thrombin generation is abrogated from blood contained in either plastic or siliconized glass tubes in the presence of 7.5 μg/mL α-FXI. These results illustrate the severity of contact pathway contribution from both glass and plastic products, as well as well as the robust mitigation provided by the inclusion of 7.5 μg/mL monoclonal anti-FXI antibody.

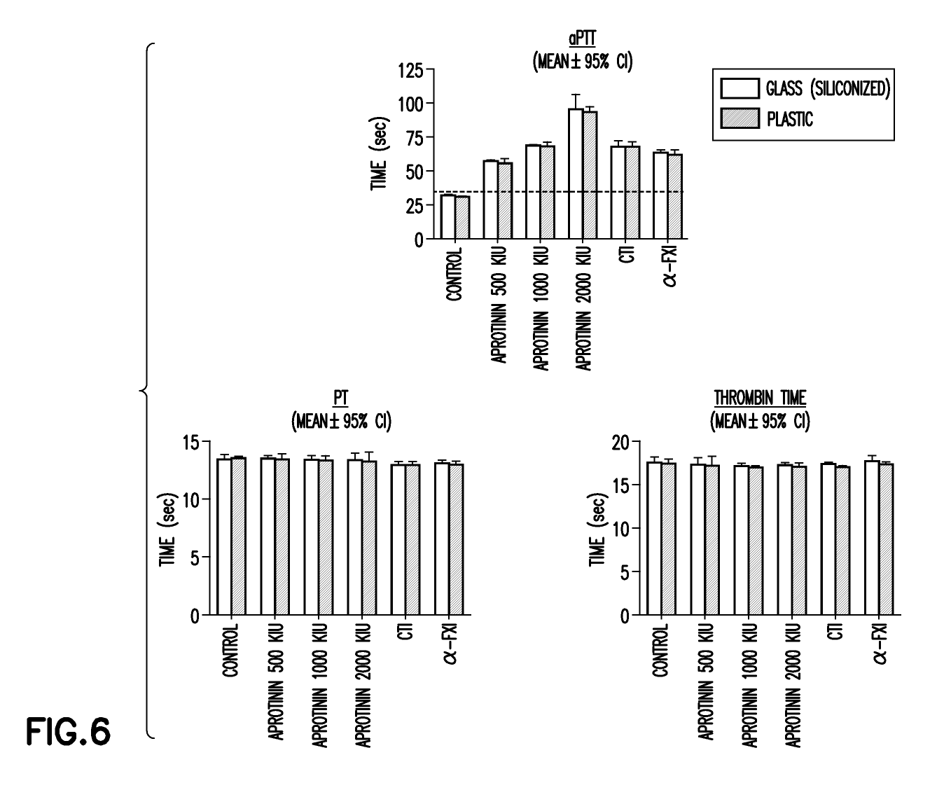

FIG. 6 was obtained by performing matched aPTT, PT, and TT assays from plasma containing various inhibitors. These assays are well known to those skilled in the art and are not described in great detail here. Aprotinin demonstrated a dose dependent effect on the aPTT as expected since the aPTT assay utilizes potent contact pathway activating chemistry to drive coagulation. Anti-FIX antibodies (7.5 μg/mL) showed a significant delay in aPTT results. Corn trypsin inhibitor (CTI) was included as a control since it is the factor XIIa inhibitor currently available in a blood collection tube. Equivalent inhibition of the aPTT assay was achieved with all three inhibitors. Furthermore, none of the inhibitors produced prolonged PT or TT assays which utilize high dose tissue factor and exogenous thrombin, respectively, to generate a clotting time result. This data indicates that aprotinin is acting selectively to inhibit contact coagulation pathway activation rather than behaving as a broad spectrum serine protease inhibitor as it is used in other blood collection applications.

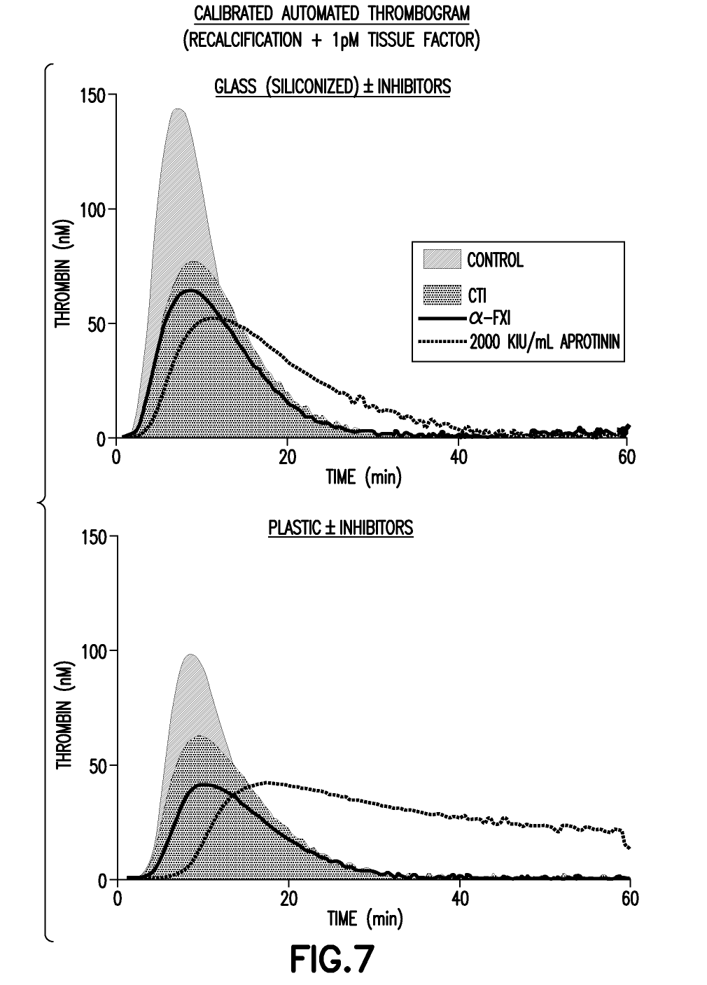

FIG. 7 provides a comparison of kallikrein, factor XIIa, and factor IX inhibition for the purposes of mitigating contact pathway contributions to thrombin generation. This data provides evidence that targeting contact pathway inhibition either upstream or downstream of factor XIIa can be as effective as direct XIIa blockade. However, only aprotinin is sterilization stable where CTI is not. Like CTI, anti-FIX is also sterilization unstable.

Based on the above results, the present invention contemplates the use of an additive that includes at least one of: i) a factor XI inhibitor that is for example but not limited to anti-human FXI antibodies; ii) a factor XII Inhibitor; and iii) a kallikrein inhibitor; and iv) any combination of i, ii, and iii. Examples of factor XIIa inhibitors include but are not limited to corn trypsin inhibitor. Examples of kallikrein inhibitors include but are not limited to aprotinin.

In a preferred embodiment, the tube includes sodium citrate as the anticoagulant in addition to the additive. However, in the presence of excess calcium, the mild chelating effect of citrate is overcome and the coagulation cascade is re-enabled if sodium citrate is the sole anticoagulant. The cascade is accelerated in the presence of clot activators. Typically, coagulation assays utilize strong clot activators (either contact pathway or tissue factor based) to produce a rapid and robust clotting reaction after recalcification.

Accelerated thrombin generation has been observed in the field during blood collection with the BD Vacutainer glass citrate tubes used in combination with tissue factor based thrombin generation assays. Glass is a highly procoagulant surface and despite manufacturing efforts to pacify that surface activation with a siliconizing coating process, there is data to demonstrate that a significantly greater amount of contact pathway activation occurs in glass citrate tubes relative to plastic citrate tubes. Although plastic citrate tubes partially mitigate the contact pathway activation seen in coated glass tubes, they do not entirely mitigate the pool of active FXII that can accumulates in blood containment device. Corn trypsin inhibitor (CTI) is a widely known FXIIa inhibitor that has shown efficacy in reducing contact pathway contributions to thrombin generation assays, a common example of which is the CAT assay from Diagnostica Stago. Here we show that, by inhibiting kallikrein or FXI with the use of either aprotinin or a monoclonal anti-FXI antibody, respectively, contact pathway contributions to the thrombin generation profile are robustly diminished from both BD Vacutainer® glass and plastic citrate tubes.

Examples of citrate tubes suitable use in the present invention with the additives described herein include, but are not limited to, citrate tubes sold by Becton, Dickinson and Company (Franklin Lakes, N.J.) (plastic tubes designated by catalog numbers 366392, 366393, 366415, 367947, 369714; glass tubes designated by catalog numbers 363080 and 363083).

In one embodiment the additive is anti-FXI antibodies with or without other relevant inhibitors in an evacuated blood collection citrate tube. The amount of anti-FXI antibodies is selected to provide stability over a desired shelf life, manufacturability, and no evidence of hemolysis.

In other embodiments, the anti-human FXI antibodies are combined with either corn trypsin inhibitor (Factor XII inhibitor) or aprotinin (kallikrein inhibitor) or some combination of the inhibitors. The additives improve the contact pathway blockade and possibly lower the amount of FXIIa inhibitor required to achieve effective blockade. In other embodiments, aprotinin alone, in concentrations of approximately 1000 to approximately 5000 KIU/mL are used for contact pathway inhibition.

The additive is present in the collection device in an effective amount to suppress the contact coagulation pathway mediated generation of thrombin. Thrombin generation is suppressed when the sample clotting time is extended from what the clotting time would have been without the additive. The choice of a specific additive and the amount or concentration to include in the device depend on several factors including the nature of the sample, the potency of each agent and its solubility in water, the amount of time blood stabilization is desired, the volume of the blood collection device, the extent of hemolysis caused by the addition of the agent to the sample, and the nature and extent of non-specific interactions (e.g., due to presence of other proteins in blood such as serum albumin). Accordingly, for purposes of the present invention, the amount of the additive(s) that may be present is more conveniently expressed in terms of a range of concentration (from which the actual amount of the agent can be easily calculated).

The additives described herein inhibit contact coagulation pathway mediated thrombin generation from being induced as an artifact of collection, transport, and storage in typical blood collection devices for in vitro diagnostic procedures. Such inhibition is described as contact pathway inhibition herein.

Some additives are more potent than others, and thus will require a smaller concentration per ml of sample, depending on the utility.

Skilled practitioners will appreciate the hemolyzed samples are an obvious visual clue that damage to blood cells has occurred, either during the collection, transport, or storage of blood samples. Although hemolysis is not necessarily detrimental to any one clinical assay, it is a well-known interference for some tests, and thus it is preferable to avoid causing hemolysis. Hemolysis can be measured by visual scale (e.g., mild or slightly pink, moderate or noticeably red, or severe or dark red). Hemolysis can also be measured by spectroscopic measurement of the red color of the hemoglobin itself, and can be reported by the concentration of hemoglobin released into the serum or plasma (e.g., such that less than about 20 mg/dL concentration of released hemoglobin, or to an extent that the hemoglobin concentration cannot be measured visually or by spectroscopy represents “minor or negligible” hemolysis, about 20 to about 100 mg/dL represents “mild” hemolysis, about 100 to about 300 represents “moderate” hemolysis, or greater than about 300 mg/dL represents “severe” hemolysis).

The contact coagulation pathway mediated thrombin generation inhibitor agent may be in any suitable form including a solution, suspension or other liquid, a pellet, a tablet, a capsule, a spray-dried material, a freeze-dried material, a powder, a particle, a gel, crystals or a lyophilized material. The blood stabilizing agent is preferably introduced into the reservoir of the container in such a form so as to optimize the shelf life of the agent, i.e., to prevent degradation of the blood stabilizing agent which would result in reduced efficacy. In addition to being disposed in the reservoir, the contact coagulation pathway mediated thrombin generation agent may be located on any surface of the device. The contact coagulation pathway mediated thrombin generation agent may also be disposed on the interior wall, on stoppers and seals for closing such devices or on mechanical, or other inserts placed within such devices.

The additives and anticoagulant(s) may be disposed in the reservoir and/or elsewhere in the device provided that they come into contact with the sample in order to provide their intended effect. For example, these ingredients may also be disposed on the interior wall, on stoppers and seals for closing such devices or on mechanical or other inserts placed within such devices.

The methods of the present invention include introducing blood or a blood sample, into the device containing the blood stabilizing agent. In some embodiments, the blood sample is withdrawn from the patient directly into the container without any intervening process steps. In other embodiments, the collected sample is further processed to prepare a composition such as an enriched composition containing a blood component such as PRP.

To facilitate use of the present invention, one or more of the devices may be packaged in the form of a kit. In some embodiments, the kit will include one or a plurality of devices, e.g., arranged in open racks or in a sealed package. The kits may also contain one or more elements that are useful drawing and collecting blood, e.g., needles, tourniquets, bandages, alcohol and wipes, and lancets. Kits may also include other types of blood collection devices such as tubes, that have disposed therein known blood stabilization agents and/or anti-coagulants, examples of which include EDTA tubes (e.g., for routine hematology counts), heparin tubes (for clinical chemistry), citrate tubes (for coagulation testing), and other specialty tubes (for use in proteomics, genomics, and the like). The kits of the present invention may also include instructions for use.

In some other embodiments, the kit may include a primary collection device, e.g., a plasma tube with a plasma separating tube having a separating element therein, and a secondary tube for testing, e.g., for pouring or otherwise dispensing the collected plasma. The separating element in the primary tube may be of an appropriate density to enable isolation of platelet-rich plasma from the other cellular content of the blood. The secondary testing tube may be of the same or different size than the primary tube, depending on the desired testing. Both tubes may have a platelet stabilizing agent disposed therein. The kit may further include a tube-to-tube transfer device to prevent the need for pouring or other unsafe transfer practices, in which case the secondary tube would be at a reduced pressure to draw in the plasma.

The invention will now be described in terms of the following non-limiting examples.

### EXAMPLE 1

Thrombelastography (TEG) is useful in testing coagulation efficiency of whole blood (WB) and has found important applications during surgery and anesthesiology. The CAT assay performed in plasma is used to investigate patients with hypo- or hypercoagulopathies. These assays are highly sensitive relative to traditional coagulation tests and vulnerable to contact activation where accumulated factor XIIa in citrated specimens can markedly augment down-stream thrombin generation (TG). Accordingly, the effect of blood collection tubes comprised of different polymeric containment materials and the select use of targeted intrinsic pathway inhibitors on select outputs of the TEG and CAT assays are examined.

Citrated human WB is transferred from a blood collection bag into coated (siliconized) glass or plastic blood collection tubes, or uncoated glass, polypropylene (PP), polystyrene (PS), or polyethylene terephthalate (PET) conical bottom tubes, either alone or in the presence of inhibitors targeting kallikrein (e.g. aprotinin) or FXIa (e.g. anti-human Factor XI antibody). After 15 minutes incubation, the TEG R value is obtained immediately after addition of 10 mM CaCl₂. Matched plasma specimens are analyzed by the CAT in the presence and absence of 1 picomolar Tissue Factor (TF) and by activated partial thromboplastin time (APTT; Stago Compact). Data are analyzed by ANOVA with Tukey's post-test and by linear regression.

Plastic blood collection tubes delivered significantly higher WB clotting “R” times (CT) (15.0±1.02 min) than either uncoated glass (6.3±0.73) or coated glass tubes (9.9±0.58) p<0.01 while providing equivalent results to all other plastic containers which ranged from 15±1.0 to 17.7 ±1.9 min, p>0.05. APTT assays were insensitive to differences between uncoated glass (29.5±1.6 s) and PP (29.8±+/−0.6 s) tubes. Moreover, CAT peak thrombin levels were significantly lower in plastic collection tubes relative to coated glass both in the absence (22.2±4.4 nM versus 167.7±nM, p<0.05) and presence (16.7±3.4 nM versus 127.3±9 nM (p<0.05) of TF. TEG WB CT correlated well with TF-initiated CAT lag time (R²=0.8116), time to peak TG (R²=0.8308) and peak TG, the latter in the absence of intrinsic inhibitors (R² =0.8401). Targeted inhibition of kallikrein also increased WB CT in uncoated glass samples from 4.9±0.30 to 27.5±8.30, which was significantly higher than both coated glass tubes (9.4±0.40) or plastic tubes (14.3±2.60) in the absence of inhibitor (p<0.001). Similarly, targeted inhibition of FXIa increased WB TEG CT in coated glass and plastic tubes above 18 min and abrogated TG in the absence of TF.

Plastic blood collection tubes offered advantages over coated glass for the CAT and TEG while the APTT assay was insensitive to these polymeric differences. Inhibition of kallikrein, even in uncoated glass, elevated WB CT beyond that of plastic suggesting additional benefits of contact pathway inhibition beyond those polymer-mediated. Inhibiting FXIa abolished TG in the absence of TF.

### EXAMPLE 2

As shown in FIG. 4(A) various concentrations of aprotinin were used in tests to determine the impact on whole blood clotting time using TEG. Citrated blood samples incubated in uncoated glass tubes were subjected to different concentrations of aprotinin measured in KIU (kallikrein inhibiting units)/mL and compared to blood samples without aprotinin but contained in siliconized glass tubes or plastic tubes. Results from this assay show that concentrations of aprotinin of 1000 KIU/mL and higher mitigate the contact coagulation pathway in uncoated glass tubes to a level equivalent to mitigation of the contact coagulation pathway in blood samples stored in siliconized glass tubes or plastic tubes.

CAT assay of samples with different amounts of aprotinin show that as aprotinin amounts is increased per sample, thrombin generation is decreased and delayed, even in the presence of CaCl₂ and TF. This result is shown in FIG. 4(B) for siliconized glass (top panel) and plastic tubes (lower panel). The control for these tests was a plurality of tubes containing the same citrated human whole blood in the absence of aprotinin.

### EXAMPLE 3

The aPTT assay was used to show that aprotinin mitigated the contact coagulation pathway in a manner equivalent to inhibition by CTI and anti-Factor XI antibody. As shown in FIG. 6, increased amounts of aprotinin prolong the time to generate thrombin that or equivalent to or greater than the time to generate thrombin in the presence of CTI and anti-Factor XI antibody. FIG. 6 (lower panels) show that using the identical samples in tests that monitor the TF coagulation pathway exclusively, the thrombin generation is unaffected by aprotinin, CTI or anti-Factor XI antibody. This verifies that aprotinin exclusively suppresses thrombin formation through the contact coagulation pathway but not through the TF pathway.

### EXAMPLE 4

FIG. 7 demonstrates that when using the CAT assay, appropriate amounts of aprotinin can mitigate the contact coagulation pathway generation of thrombin in a manner equivalent to that of CTI and anti-Factor XI antibody. An advantage of using aprotinin over CTI or anti-Factor XI antibody is that neither of the latter two inhibitors can be present in a tube that has been sterilized.

Although the invention herein has been described with reference to particular embodiments, it is to be understood that these embodiments are merely illustrative of the principles and applications described herein. It is therefore to be understood that numerous modifications may be made to the illustrative embodiments and that other arrangements may be devised without departing from the spirit and scope of the various embodiments described herein as defined by the appended claims.

1. A device for collecting and stabilizing blood or a component thereof, wherein the device has a first end and a second end and at least one interior wall defining a reservoir portion for receiving a blood sample, wherein the reservoir contains an anticoagulant and an additive present in an effective amount to inhibit the contact pathway for thrombin generation comprising at least one of a Factor XI inhibitor, a Factor XII inhibitor, a kallikrein inhibitor and combinations thereof.

2. The device of claim 1, which is sterile and evacuated, and further comprises a closure pierceable by a needle.

3. The device of claim 2, which is a tube.

4. The device of claim 3, which further comprises a separator.

5. The device of claim 1, wherein the additive comprises a Factor XI inhibitor and that inhibitor is anti-human FXI antibody.

6. The device of claim 1, wherein the additive comprises a kallikrein inhibitor and that kallikrein inhibitor is aprotinin.

7. The device of claim 6, wherein the additive comprises a Factor XII inhibitor and that Factor XII inhibitor is corn trypsin inhibitor.

8. The device of claim 1, wherein the additive comprises aprotinin in combination with at least one other inhibitor selected from the group consisting of anti-human FXI antibody and corn trypsin inhibitor.

9. The device of claim 1, wherein the contact pathway inhibitor additive agent is in dried form.

10. The device of claim 1, wherein the anti-coagulant is sodium citrate.

11. A method for stabilizing blood, comprising introducing blood or a composition comprising a blood component into a device that has a first end and a second end and at least one interior wall defining a reservoir portion for receiving the blood or the composition, wherein the reservoir contains an anticoagulant and a contact pathway inhibitor additive comprising at least one of a Factor XI inhibitor, a Factor XII inhibitor, a kallikrein inhibitor and combinations thereof, the contact pathway inhibitor additive being present in an amount effective to inhibit the contact pathway for thrombin generation.

12. The method of claim 9, wherein the composition is a drawn blood sample.

13. The method of claim 11, wherein the composition is platelet-rich plasma (PRP).

14. The method of claim 11, wherein the contact pathway inhibitor additive comprises a Factor XI inhibitor and that Factor XI inhibitor is human anti-Factor XI antibody.

15. The method of claim 11, wherein the contact pathway inhibitor additive comprises a Factor XII inhibitor and that Factor XII inhibitor is corn trypsin inhibitor.

16. The method of claim 11, wherein the contact pathway inhibitor additive comprises, in combination, a Factor XI inhibitor, a Factor XII inhibitor, and a kallikrein inhibitor wherein the kallikrein inhibitor is positioned to contact the blood or blood composition upstream of the Factor XI and Factor XII inhibitors.

17. The method of claim 16, wherein the kallikrein inhibitor is aprotinin.

18. A method for treating blood for an assay in vitro, comprising introducing blood or a composition comprising a blood component into a device having a first end and a second end and at least one interior wall defining a reservoir portion for receiving blood or a composition comprising a component of blood, wherein the reservoir contains an anticoagulant and an additive that inhibits the contact pathway for thrombin generation comprising at least one of a Factor XI inhibitor, a Factor XII inhibitor, a kallikrein inhibitor and combinations thereof wherein the Factor XI inhibitor is anti-human FXI antibody and the kallikrein inhibitor is aprotinin in a concentration effective to inhibit the contact pathway for thrombin generation.

19. A kit comprising at least one device for collecting blood or a composition comprising a component of blood, wherein the device has a first end and a second end and at least one interior wall defining a reservoir portion for receiving the blood or the composition, wherein the reservoir contains an anticoagulant and an additive that inhibits the contact pathway for thrombin generation comprising at least one of a Factor XI inhibitor, a Factor XII inhibitor, a kallikrein inhibitor and combinations thereof wherein the Factor XI inhibitor is anti-human FXI antibody and the kallikrein inhibitor is aprotinin in a concentration effective to inhibit the contact pathway for thrombin generation.

20. The kit of claim 19, which is sterile and evacuated, and further comprises a closure pierceable by a needle.

21. The kit of claim 20, which is a tube.

22. The kit of claim 21, which further comprises a separator.

23. The kit of claim 19, wherein the additive comprises a factor XI inhibitor and that inhibitor is anti-human FXI antibody.

24. The kit of claim 19, wherein the additive comprises a kallikrein inhibitor and that kallikrein inhibitor is aprotinin.

25. The kit of claim 24, wherein the additive comprises a Factor XII inhibitor and that Factor XII inhibitor is corn trypsin inhibitor.

26. The kit of claim 19, wherein the additive comprises aprotinin in combination with at least one other inhibitor selected from the group consisting of anti-human FXI antibody and corn trypsin inhibitor.

27. The kit of claim 19, wherein the contact pathway inhibitor additive agent is in dried form.

28. The kit of claim 19, wherein the anti-coagulant is sodium citrate.
